(19) United States
(12) Patent Application Publication
(10) Pub. No.: US 2012/0114911 A1
(43) Pub. Date: May 10, 2012

(54) BUILDING CONSTRUCTION PART AND ITS USE, AS WELL AS THE METHOD TO MANUFACTURE THE PART

(76) Inventor: Jukka Lommi, Helsinki (FI)

(21) Appl. No.: 13/376,234

(22) PCT Filed: Jun. 2, 2010
(86) PCT No.: PCT/FI10/00041

§ 371 Date: Jan. 24, 2012

(30) Foreign Application Priority Data
Jun. 2, 2009 (FI) 20090222

(51) Int. Cl. B32B 21/04; B32B 21/14; B32B 3/28; B27M 1/00

(52) U.S. Cl. 428/172; 144/359; 428/174

(57) ABSTRACT

A building construction part which includes several dimensionally exact pieces made by milling, sawing, cutting or otherwise removing, which are free-form in appearance and attached on top of each other to form a structurally rigid construction part. A method to manufacture the building construction part is also described.

A building construction part and its use, as well as the method to manufacture the part

The object of this patent is a method to manufacture a building construction part or a building element as well as a building element made using this method and how it can be used.

The known wooden building construction parts: the walls, ceiling or floor usually have structures which have a separate supporting structure with covering and insulating structures which are attached to the supporting structure with fastening systems. In addition to this, due to the manufacturing methods and measuring of wooden construction standard parts, these building construction parts are mainly rectangular building construction parts, made of straight boards or other rectangular building construction parts of different strengths. If a free-form building construction part is required, it is made of a separate frame and bent wooden boards or battens.

The object of this invention is to remove this restriction and to achieve a wooden building element, which has a wave shaped appearance and which is at the same time supporting and rigid without a separate supporting or stiffening structure.

This object can be achieved when the building element is made of wooden pieces being exactly dimensioned wave shaped pieces separated from a wooden board, especially a Kerto, i.e. a laminated veneer lumber (LVL) board by milling, sawing, cutting or in any other way, which pieces when attached on top of each other form a structurally rigid building element, which can be used as a supporting outer wall or partition wall, a roof, an intermediate floor or a base floor of a builidng, or as another building construction part, in such a way that it is either rigid and supporting or only rigid due to its manufacture, in which case it can be attached to the supporting frame of the building. The shaped pieces, which form a building element after they are attached to each other, can be of the same shape or of a different shape. Attached on top of each other in this application means that the straight level surfaces of the shaped pieces are attached to each other horizontally. The rigidity and supportiveness required with the manufacturing process is achieved by using wave shaped curved shapes and by increasing the material thickness of the construction piece at required places.

The material thickness of a building element or a piece in this application means the measure of the building element or piece vertically against the board's cutting direction when level with the sheet, and it is hereby called horizontal material thickness or material thickness on a horizontal level. The wave shaped pieces are attached to each other mainly by gluing or using other fastening systems.

The glue being used is determined according to the purpose of use of the building element and according to the wooden board being used. Due to this method the shape of the building element is wave shaped. Usually the wooden board to be used is plywood, adhesive wooden board, Kerto i.e laminated veneer lumber (LVL) or a woodchip board. The board thicknesses vary between 20 mm and 75 mm depending on the board. The building construction part in this invention can be either a separately designed and measured unique piece, or a standardised part.

The characteristics for the building element according to the invention are presented in the characterizing part of the claim 1, and for the method according to the invention in the characterizing part of the claim 6.

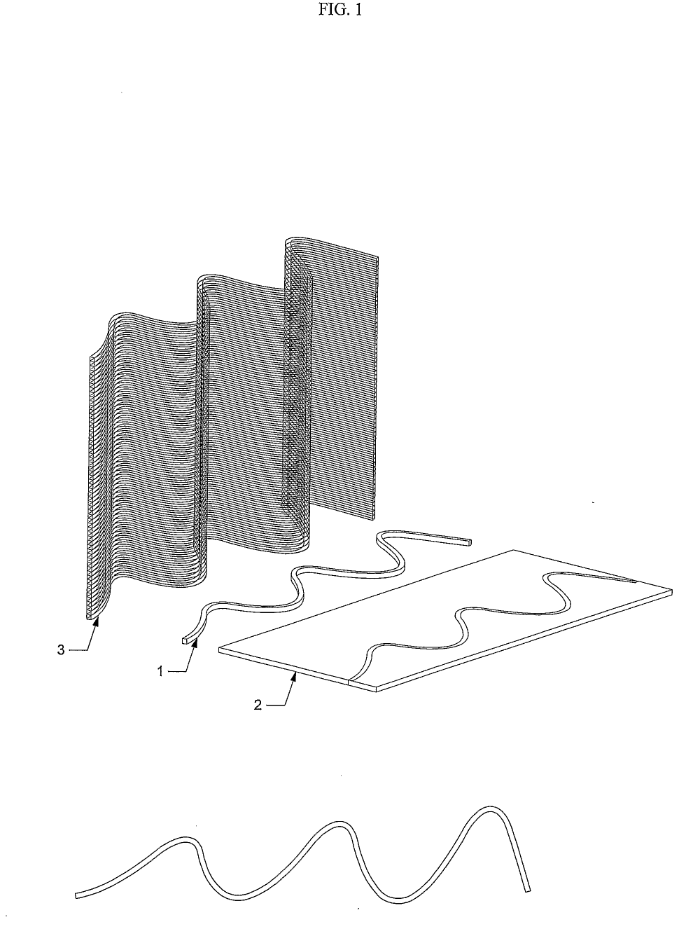

The following describes the invention in more detail by referring to the FIGS. 1, 2 and 3, which describe three different applications for the building element.

FIG. 1: the building element, here a wall (3), is made of 60 pieces milled from 51 mm thick Kerto boards (2), which are pieces (1) of similar shape of an even material strength and which are glued together. The curvature of the milling form is sufficient to make sure that the structure is rigid and supportive. The calculated definition for the bearing capacity and rigidity must be always performed separately for each building element in order to achieve the sufficient and satisfactory standard.

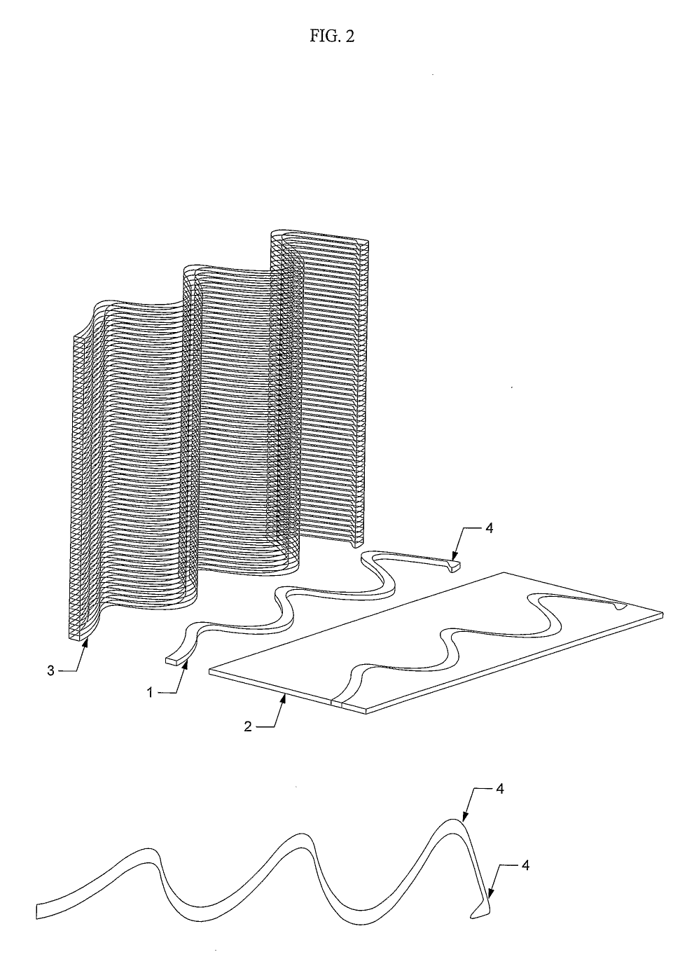

FIG. 2: the building element, here a wall (3), is made of 60 pieces milled from 51 mm thick Kerto boards (2), which are pieces of similar shape (1) and glued together. The milling shape curvature and the increases (4) made to the material thickness used as additional reinforcement at required points, are sufficient to ensure that the structure is rigid and supportive. The calculated definition for the bearing capacity and rigidity must be always performed separately for each building element in order to achieve the sufficient and satisfactory standard.

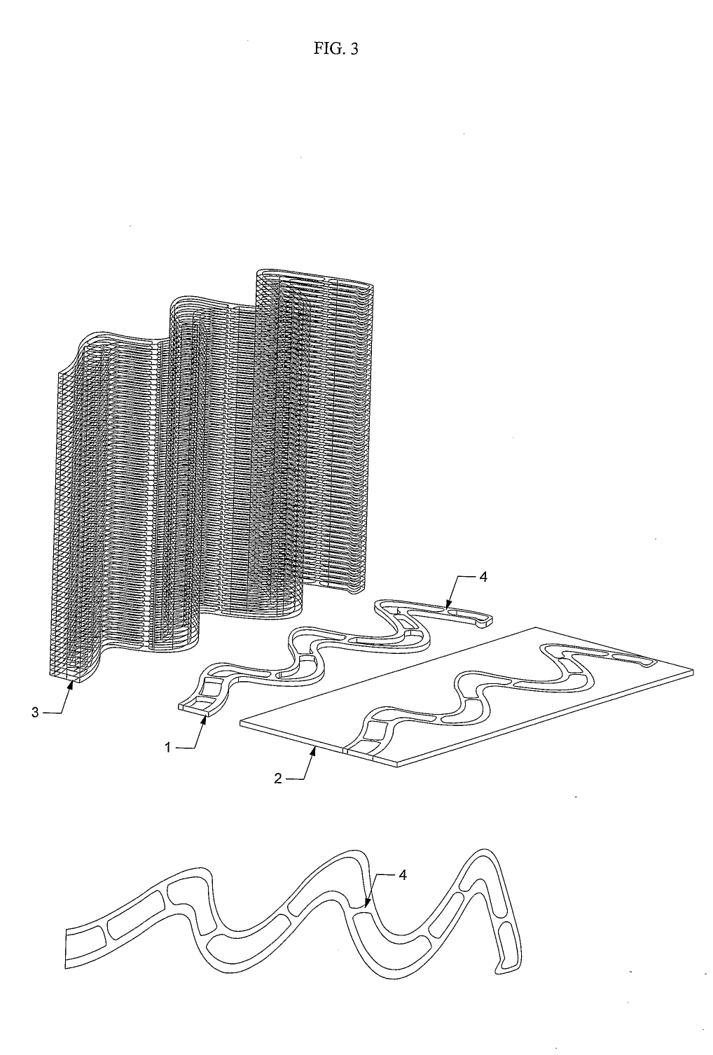

FIG. 3: the building element, here a wall (3), is made of 60 pieces milled from 51 mm thick Kerto boards (2), which are pieces of similar shape (1) and glued together. The curvature and the cell-like structure of the milling shape with attachment points (4) binding the outer and inner frame are sufficient to ensure that the structure is rigid and supportive. The calculated definition for the bearing capacity and rigidity must be always performed separately for each building element in order to achieve the sufficient and satisfactory standard.

The building elements of the invention can have openings, smaller drillings and lead-ins, which serve house construction requirements, for example, and can be openings such as those for a window or a door. With cell-structure the cell can be used separately as a place for insulation material.

1-9. (canceled)

10. A building element (3) comprising a plurality of wooden pieces (1) attached on top of each other, characterized in that said wooden pieces (1) are exactly dimensioned wave shaped pieces (1) separated from a wooden board (2), especially a Kerto, i.e. a laminated veneer lumber (LVL) board by milling, sawing, cutting or in any other way, which pieces (1) when attached on top of each other form a structurally rigid building element (3).

11. A building element according to the claim 10, characterized in having an increased horizontal material thickness at required places.

12. A building element according to claim 11, characterized in that the exactly dimensioned piece (1) has a cellular structure, whereby the places (4) having an increased material thickness are bars connecting the outer and inner walls of the piece (1).

13. A building element according to claim 10, characterized in that the exactly dimensioned pieces (1) have been attached to each other by gluing.

14. A building element according to claim 11 characterized in that the exactly dimensioned pieces (1) have been attached to each other by gluing.

15. A method for manufacturing a building element according to claim 10, characterized in that exactly dimensioned wave shaped pieces (1) are milled, sawn, cut or otherwise removed from a wooden board (2), especially a Kerto, i.e. a laminated veneer lumber (LVL) board , and attached on top of each other to form a structurally supportive building element (3).

16. A method according to claim 15, characterized in that the exactly dimensioned pieces (1) are selected in such a way that the pieces (1), when attached on top of each other, increase the horizontal material thickness of the building element (3) at required places.

17. A method according to claim 15, characterized in that the exactly dimensioned pieces (1) are attached to each other by gluing.

18. A method according to claim 16, characterized in that the exactly dimensioned pieces (1) are attached to each other by gluing.
